(19) United States
(12) Patent Application Publication
(10) Pub. No.: US 2003/0213916 A1
(43) Pub. Date: Nov. 20, 2003

(54) VUV-attenuating windows

(76) Inventor: Kevin J. Orvek, Worcester, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/150,331

(22) Filed: May 16, 2002

(51) Int. Cl. B29D 11/00; G02B 1/00

(52) U.S. Cl. 250/372; 264/1.23; 264/2.7; 700/198

(57) ABSTRACT

Windows for attenuating vacuum ultraviolet (VUV) light are created by adding metallic material to a fluoride crystalline material during manufacturing. The amount of attenuation in the final window may be controlled by controlling the manufacturing process to control the amount of metallic material remaining in the window after manufacture. If the distribution of metallic material from one window to another is inconsistent, the windows may be measured and sorted by their attenuation characteristics.

### BACKGROUND

1. Technical Field

An embodiment of the invention pertains generally to transmission windows for ultraviolet light, and in particular pertains to controlling the amount of attenuation of vacuum ultraviolet light transmitted through a window by controlling the window fabrication process.

2. Description of the Related Art

Ultraviolet light with a wavelength of 100-200 nanometers (nm) is commonly called vacuum ultraviolet (VUV) light. Controlled levels of VUV light have various applications, including lithographic processes used in semiconductor fabrication. While a fairly strong intensity of VUV light may be required to perform a useful function, the sensors that measure the level of that intensity can frequently be damaged if exposed to the full strength of the light. Special purpose windows are used to protect these sensors by attenuating the VUV light to an acceptable level before the light strikes the sensor. One example is the use of fused silica windows to attenuate light for dose detectors in lithography scanners. However, although the sensors may be protected by the windows, the fused silica windows themselves typically degrade over time with exposure to VUV light by becoming darker and then opaque. The windows must be repeatedly replaced, which can increase operational costs in at least three ways: 1) Replacing the windows may be costly, in terms of the cost of the replacement windows, human labor to perform the replacement, and downtime on the associated equipment, 2) To get maximum life out of each window, the windows may be periodically tested to determine whether the attenuation has moved out of an acceptable range, and 3) If no testing is used, windows may be replaced frequently to accommodate worst-case degradation, resulting in premature replacement for many windows.

### BRIEF DESCRIPTION OF THE DRAWINGS

The invention may be understood by referring to the following description and accompanying drawings that are used to illustrate embodiments of the invention. In the drawings:

FIG. 1 shows a system with a cross-sectional depiction of a VUV-attenuating window, according to one embodiment of the invention.

FIG. 2 shows certain components that are used in creating a VUV-attenuation window, according to one embodiment of the invention.

FIG. 3 shows a flow chart of a process to create VUV-attenuating windows, according to one embodiment of the invention.

### DETAILED DESCRIPTION OF THE INVENTION

In the following description, numerous specific details are set forth. However, it is understood that embodiments of the invention may be practiced without these specific details. In other instances, well-known structures and techniques have not been shown in detail in order not to obscure an understanding of this description.

References to “one embodiment”, “an embodiment”, “example embodiment”, “various embodiments”, etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

Various embodiments of the invention include an optical window to attenuate VUV light, the window comprising a crystalline fluoride material and a metallic material distributed within the crystalline fluoride material. Because the attenuation is provided by metal within the window that does not deteriorate with exposure to VUV light, the windows may not suffer from the operational degradation that conventional VUV-attenuating windows experience. Within the context of various embodiments of the invention, a window is an optically-transmissive device that permits at least a portion of VUV light to pass through the window.

Embodiments of the invention may be implemented in one or a combination of hardware, firmware, and software. Embodiments of the invention may also be implemented as instructions stored on a machine-readable medium, which may be read and executed by at least one processor to perform operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

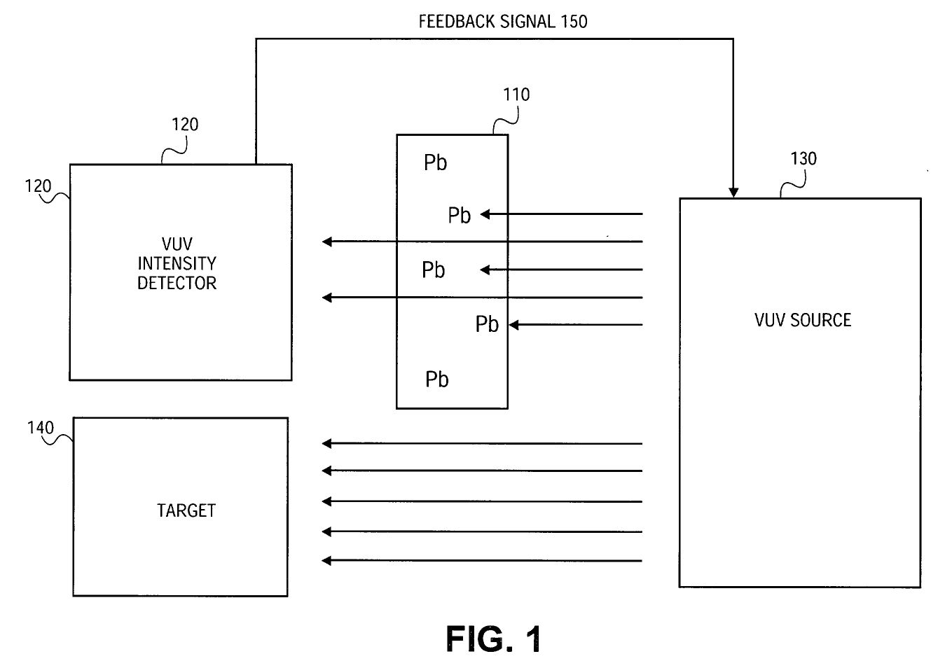

FIG. 1 shows a system with a cross-sectional depiction of a VUV-attenuating window, according to one embodiment of the invention. In one embodiment the window 110 is comprised of a crystalline form of a fluoride compound containing a metallic material. In particular embodiments, the fluoride compound may include at least one of calcium fluoride (CaF₂), magnesium fluoride (MgF₂), strontium fluoride (SrF₂), barium fluoride (BaF₂), but other embodiments may use other compounds. While in the illustrated embodiment the metallic material includes lead (Pb), other embodiments may include the use of other metallic materials in the window, e.g., titanium (Ti), uranium (U), etc., either singly or in combination.

In the illustrated embodiment of FIG. 1, a VUV source 130 emits the VUV light to a target 140 at a certain intensity. To reduce the intensity to a level that can be effectively measured by VUV intensity detector 120, a portion of the VUV light is attenuated by window 110. By knowing the amount of attenuation provided by window 110 (e.g., knowing what percent of the VUV light is passed and what percent is blocked), the intensity of the non-attenuated light striking target 140 can be determined from the intensity of the attenuated light striking VUV intensity detector 120. In one embodiment a feedback signal 150 is used to adjust the intensity of the VUV light emitted from VUV source 130, based on the detected intensity measured by VUV intensity detector 120, so that a desired intensity of VUV light is directed to target 140. In an alternate embodiment there is no feedback signal 150 for real-time adjustment of intensity, and the intensity of VUV light from VUV source 130 may be pre-set.

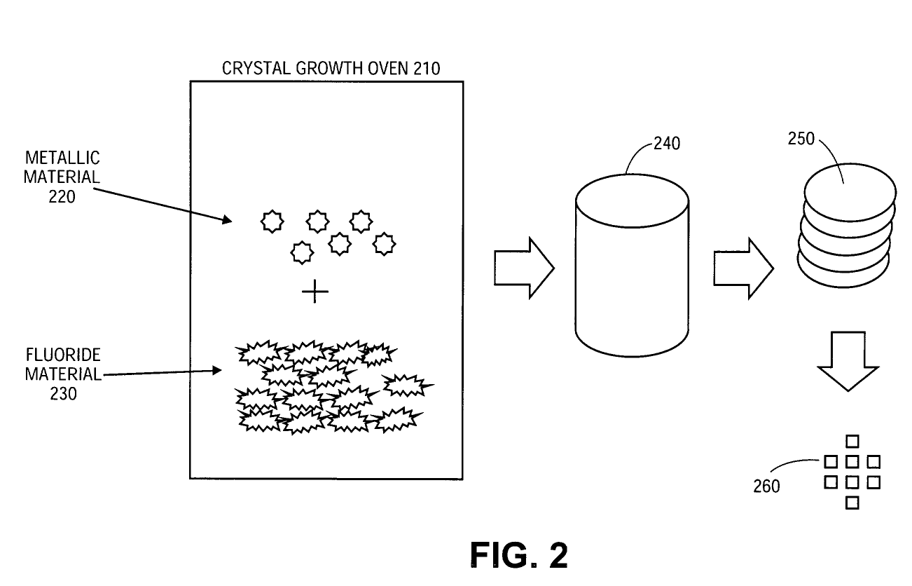

FIG. 2 shows certain components that are used in creating a VUV-attenuation window, according to one embodiment of the invention. FIG. 2 shows a crystal growth oven 210, a metallic material 220, a fluoride material 230, a crystal ingot 240, blanks 250, and VUV-attenuating windows 260. While in one embodiment metallic material 220 comprises a metallic element (i.e., a metal that is listed in the periodic table of chemical elements), in another embodiment metallic material 220 comprises a metallic compound (i.e., atoms of metal bonded with atoms of other elements).

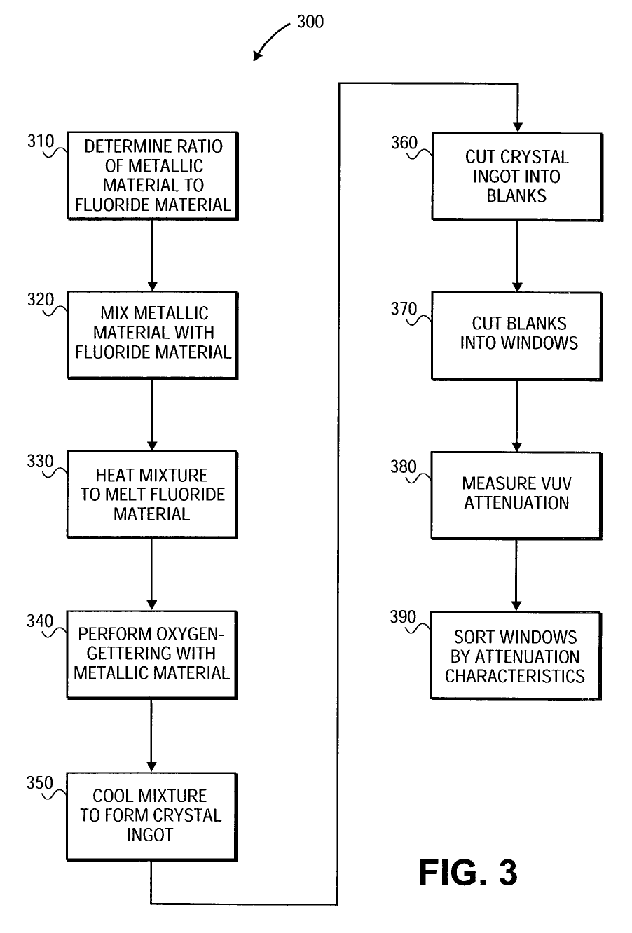

FIG. 3 shows a flow chart of a process to produce VUV-attenuating windows, according to one embodiment of the invention. In the following text, the flow chart 300 of FIG. 3 and the components of FIG. 2 are sometimes described with reference to one another. However, it is understood that the process of FIG. 3 may operate upon components other than those shown in FIG. 2, and the components of FIG. 2 may be operated upon by processes other than that of FIG. 3.

With reference to FIG. 3, at block 310 the ratio of initial metallic material to initial fluoride material is determined. While in one embodiment the ratio is in a range of 0.1-10% of initial metallic material by weight, other embodiments may use ratios outside this range. The ratio of initial materials may be affected by both the desired ratio of metal to fluoride in the final windows, and by the amount of metallic material expected to be lost during processing. The desired ratio of metal to fluoride in the final windows depends on various factors, including but not limited to: 1) the amount of attenuation needed for a particular wavelength of VUV light, 2) the thickness of the windows, 3) the type of metal being used, and 4) the presence of other materials in the window that affect absorption of VUV light. The desired ratio of initial metallic material to initial fluoride material depends on the desired ratio in the final windows (and thus on the factors just listed), as well as on the amount of metallic material in the initial materials that is dispelled during processing.

In one embodiment, the fluoride material is a commercial-grade form of crystalline fluoride containing trapped oxygen, but other embodiments may use other compounds. Oxygen absorbs VUV light, and any oxygen remaining in the final window acts as a VUV attenuation mechanism. It may be difficult to control the amount of absorption if oxygen remains in the final window, so a first portion of the metallic material may include a metallic element to be used as an oxygen-gettering agent. The oxygen-gettering agent reacts with the oxygen when the fluoride material is melted, forming a metallic oxide. The metallic oxide then evaporates from the melted fluoride material before the crystal is formed, thus removing the oxygen and part of the metallic material from the fluoride material. Therefore a first portion of the metallic material may be determined as the amount necessary to remove the oxygen in this manner, and may be calculated based on the oxygen content of the starting fluoride material. An additional, or second, portion of the metallic material may also be added to the fluoride material, to remain in the fluoride material after the crystal is formed. The amount of this second portion may be pre-determined, based on the amount of metallic material that is to remain in the final windows. While in one embodiment the second portion comprises the same metallic material as the first portion, in an alternate embodiment the second portion may comprise one or more different metallic material than the first portion. While in one embodiment both the metallic material and the fluoride material are in powder form, in other embodiments one or both may be in one or more other forms (e.g., granules, flakes, etc.).

With reference to FIG. 2, metallic material 220 and fluoride material 230 are shown in crystal growth oven 210, in preparation for heating. Although distinct symbols are used in FIG. 2 to separately indicate the particles of metallic material 220 and particles of fluoride material 230, these symbols are intended solely to distinguish between the different substances. The physical shape of the respective particles of material may be other than the illustrated shapes.

At block 320 the fluoride material is mixed with the metallic material to provide a substantially uniform distribution of the metallic material throughout the mixture. If the metallic material includes multiple types of metallic elements and/or compounds, the mixing process may provide a substantially uniform distribution of all such metallic elements and/or compounds. Further, although the different materials are shown in FIG. 2 as being in separate groupings in the crystal growth oven 210, this is for illustration only. In one embodiment the materials are mixed together before being placed into the crystal growth oven 210, while in an alternate embodiment the materials are mixed together after placement in the crystal growth oven 210.

At block 330 the mixture of metallic material and fluoride material is heated sufficiently to melt the fluoride material. At block 340, oxygen-gettering is performed by the metallic material, as the metallic material reacts with trapped oxygen to form a metal oxide, and the metal oxide evaporates. In an embodiment in which the initial fluoride material has no (or an insignificant amount of) oxygen, the oxygen-gettering operation of block 340 may be eliminated. At block 350 the melted mixture from block 330 is cooled to form a fluoride crystal ingot (e.g., crystal ingot 240 of FIG. 2). While in certain embodiments the operations of blocks 330-350 follow standard crystal-growing procedures, in alternative embodiments the operations of blocks 330-350 may follow non-standard and/or yet-to-be developed crystal-growing procedures. Crystal growing procedures are not described in detail herein to avoid obscuring an understanding of the various embodiments of the invention.

At block 360 the crystal ingot in cut into blanks (e.g., blanks 250 in FIG. 2). At block 370 each blank is cut into one or more individual windows (e.g., windows 260 in FIG. 2. In the illustrated embodiment of FIG. 2, the windows are shown as square, but other embodiments may produce windows with other shapes (e.g., rectangular, hexagonal, circular, etc.) Windows of various dimensions may be produced. While in one embodiment the windows are between approximately 0.04-1.0 inches thick, and between approximately 2-20 inches across at the widest dimension, other embodiments may includes windows having other dimensions. While in one embodiment the windows are generally planar in shape, other embodiments may include windows with a varying thickness (e.g., wedge-shaped, convex, concave, etc.). While in one embodiment the surfaces of each window are generally smooth, other embodiments may include windows with other surface characteristics (e.g., a texture, a grating, etc.). Additional operations (not shown) may be performed to create one or more of the non-planar shapes and/or one or more of the surface characteristics. While in one embodiment these additional operations are performed on individual windows, in other embodiments at least some of these additional operations may be performed on the blanks 250 before cutting the blanks 250 into windows 260. Such additional operations may include, but are not limited to, polishing, grinding, cutting, etching, etc., using mechanical and/or chemical operations.

The VUV-attenuating characteristics of any particular window depend at least partially on the concentration of metallic elements remaining within the window after the window is manufactured. This concentration depends on various factors, some of which were previously discussed. An additional factor is the distribution of the metallic material within the crystal ingot 240 before the blanks and windows are cut. If the concentration of metallic material varies from one part of the crystal ingot 240 to another, the concentration of metallic material in a given window may depend on what part of the crystal ingot 240 the window is cut from. In view of this potential variation in the concentration of metallic material in the crystal ingot, producing windows that have attenuation characteristics within a specified range may be controlled in one or more of the following ways: 1) Thoroughly mixing the initial materials may provide a more uniform distribution of metallic material when the fluoride material is melted, thus providing a more uniform initial distribution. 2) Assuming a uniform distribution of metallic material when the fluoride material is first melted, growing a relatively small crystal ingot may provide a more consistent distribution of metallic substance in the crystal ingot because the time of crystal formation is shorter, permitting less time for the metallic material to settle while the fluoride material is in a liquid state. 3) If inconsistency in the distribution of the metallic material exists in the cooled crystal ingot, the inconsistency may be accommodated by measuring the windows to determine their attenuation characteristics as shown in block 380 of FIG. 3, and then sorting the windows by the amount of attenuation measured as shown in block 390. For a given application, a window with the required attenuation characteristics may then be selected from the sorted windows. While in one embodiment the measurements are performed on individual windows, in an alternate embodiment the attenuation of the blanks is measured before the blanks are cut into windows and all windows from a specific blank are attributed with the attenuation measured for that blank. In still another embodiment, different areas of each blank are measured for attenuation characteristics, and the windows cut from a particular area are attributed with the attenuation measured for that area.

The foregoing description is intended to be illustrative and not limiting. Variations will occur to those of skill in the art. Those variations are intended to be included in various embodiments of the invention, which are limited only by the spirit and scope of the appended claims.

What is claimed is:

1. A method, comprising:
combining a metallic material with a fluoride material in a mixture;
heating the mixture sufficiently to melt the fluoride material;
cooling the mixture to form a fluoride-based crystal ingot containing the metallic material; and
cutting the crystal ingot to produce a window having vacuum ultraviolet light-attenuation properties.

2. The method of claim 1, wherein:
the fluoride material includes at least one of calcium fluoride, magnesium fluoride, barium fluoride, and strontium fluoride.

3. The method of claim 1, wherein:
the metallic material includes at least one of lead, uranium, and titanium.

4. The method of claim 1, wherein:
said cutting includes cutting the crystal ingot into at least one window.

5. The method of claim 1, wherein:
said cutting includes cutting the crystal ingot into at least one blank and cutting the at least one blank into at least one window.

6. The method of claim 1, wherein said cutting includes:
cutting the crystal ingot into multiple windows;
measuring the multiple windows for vacuum ultraviolet light-attenuation characteristics; and
sorting the multiple windows based on the vacuum ultraviolet light-attenuation characteristics.

7. The method of claim 6, further comprising:
selecting one of the multiple windows having vacuum ultraviolet light-attenuation characteristics within a specified range.

8. The method of claim 1, wherein:
said combining includes combining the metallic material and the fluoride material in a proportion within a predetermined range.

9. An article made by a process comprising:
combining a metallic material with a fluoride material in a mixture having a proportion of the metallic material to the fluoride material within a predetermined range of proportions;
heating the mixture to melt the fluoride material;
cooling the mixture to form a fluoride-based crystal ingot containing the metallic material; and
cutting the crystal ingot to produce a window having vacuum ultraviolet light-attenuation properties.

10. The article of claim 9, wherein:
the fluoride material includes at least one of calcium fluoride, magnesium fluoride, barium fluoride, and strontium fluoride.

11. The article of claim 9, wherein:
the metallic material includes a metallic element including at least one of lead, uranium, and titanium.

12. The article of claim 9, wherein:
said cutting includes cutting the crystal ingot into at least one window.

13. The article of claim 9, wherein:
said cutting includes cutting the crystal ingot into at least one blank and cutting the at least one blank into at least one window.

14. The article of claim 9, wherein said cutting includes:
cutting the crystal ingot into multiple windows;
measuring the multiple windows for vacuum ultraviolet light-attenuation characteristics; and
sorting the multiple windows based on the measured vacuum ultraviolet light-attenuation characteristics.

15. An article, comprising:
a window to attenuate vacuum ultraviolet light passing through the window, the window including a crystalline fluoride material and a metallic material distributed within the crystalline fluoride material.

16. The article of claim 15, wherein:
the crystalline fluoride material includes at least one of calcium fluoride, magnesium fluoride, barium fluoride, and strontium fluoride.

17. The article of claim 15, wherein:
the metallic material includes at least one of lead, uranium, and titanium.

18. A method comprising:
transmitting vacuum ultraviolet light;
attenuating the vacuum ultraviolet light with a metallic material within a fluoride crystal window; and
detecting an intensity of the attenuated vacuum ultraviolet light.

19. The method of claim 18, wherein:
said transmitting includes transmitting through the fluoride crystal window having at least one of calcium fluoride, magnesium fluoride, barium fluoride, and strontium fluoride.

20. The method of claim 18, wherein:
said transmitting includes transmitting through the fluoride crystal window having at least one of lead, uranium, and titanium.

21. The method of claim 18, wherein:
said transmitting includes transmitting through the fluoride crystal window having a predetermined attenuation characteristic for the vacuum ultraviolet light.

22. A system, comprising:
a source to transmit vacuum ultraviolet light;
a window including a fluoride crystalline material and a metallic material within the fluoride crystalline material, the metallic material to attenuate a portion of the vacuum ultraviolet light passing through the window; and
a detector to detect an intensity of the attenuated vacuum ultraviolet light.

23. The system of claim 22, further comprising:
a feedback signal between the detector and the source to control an intensity of the vacuum ultraviolet light transmitted from the source, based on the intensity of the attenuated vacuum ultraviolet light detected by the detector.

24. The system of claim 22, wherein:
the fluoride crystalline material includes at least one of calcium fluoride, magnesium fluoride, barium fluoride, and strontium fluoride.

25. The system of claim 22, wherein:
the metallic material includes at least one of lead, uranium, and titanium.

26. The system of claim 22, wherein:
the window includes a proportion of the metallic material to the fluoride material within a predetermined range.

27. A machine-readable medium that provides instructions, which when executed by a set of one or more processors, cause said set of processors to perform operations comprising:
selecting a temperature and a time suitable to melt a quantity of fluoride material mixed with a metallic material;
heating the quantity in an oven to the selected temperature for the selected time to melt the fluoride material; and
cooling the quantity to form a fluoride-based crystal ingot having the metallic material therein.

28. The medium of claim 27, wherein:
said heating includes heating to perform oxygen-gettering with a portion of the metallic material.

29. The medium of claim 27, wherein:
the fluoride material includes at least one of calcium fluoride, magnesium fluoride, barium fluoride, and strontium fluoride.

30. The medium of claim 27, wherein:
the metallic material includes a metallic element including at least one of lead, uranium, and titanium.
